(19) United States
(12) Patent Application Publication
(10) Pub. No.: US 2012/0033272 A1
(43) Pub. Date: Feb. 9, 2012

(54) Calibration Mechanism And Scanning Device Has The Calibration Mechanism

(76) Inventors: Yueh-Shing Lee, Taipei (TW); Shao-Yang Wu, Taipei (TW)

(21) Appl. No.: 12/849,016

(22) Filed: Aug. 3, 2010

(51) Int. Cl. H04N 1/46

(52) U.S. Cl. 358/504; 358/505

(57) ABSTRACT

A calibration mechanism is positioned in a scanning device. The scanning device includes a scanning module having a transparent plate for being passed through a scanned light beam and creating a scanned color. The calibration mechanism includes a processor means and a display means. The display means is positioned to face the transparent plate of the scanning module and controlled by the processor means to alter the scanned color to a display color. Since, the calibration mechanism is capable altering the background color. Furthermore, the calibration mechanism has a simple structure and a compact size for conveniently positioned in a compact scanning device.

### BACKGROUND OF THE INVENTION

1. Field of the Invention

The present invention relates to a calibration mechanism, more specifically, to a calibration mechanism capable of alternating the background color and a scanner having the calibration mechanism.

2. The Related Art

Generally, a scanning module is fixed in a scanning device with an auto document feeder. A document is conveyed by rollers positioned in the auto document feeder to pass the scanning module for being scanned. Conventionally, the color of a calibration sheet positioned in the scanning device is constant.

If the scanned document is a light color paper such as a white paper, then the calibration sheet must be manually replaced as a dark color sheet such as a black color sheet. If the scanned document is a dark color paper such as a black color paper, then the calibration sheet must be manually replaced as a light color sheet such as a white color sheet. Since, the contrast is strong enough between the color of the scanned document and the color of the calibration sheet for improving de-skew function and edge detection function of the scanning device.

If the scanned document is thin and the calibration sheet is white, then the dark images printed on opposite sides of the document will be influenced each other to reduce quality of the scanned image. Therefore, the calibration sheet must be replaced as a dark sheet to prevent the influence in this case. The calibration sheet must be altered to be white or black to adjust the shade of the scanning module of the scanning device for improving the quality of the scanned image.

However, it is inconvenient to manually replace the white calibration sheet and the black calibration sheet, and store the calibration sheets. Since, the calibration mechanism capable of alternating the background color is popular nowadays.

U.S. Pat. No. 7,518,766 discloses a calibration mechanism of a scanner. The calibration mechanism of the scanner includes a second light source, a calibration element having an opening, a first light source and a scanning module. The second light source is assembled with the calibration element, and the first light source is disposed at a position opposite to the calibration element. During the shading correction, the calibration element is rotated by an angle so that the first light source illuminates on a surface of the calibration element, and the reflected light enters the scanning module. When a transmissive original is being scanned, the light of the second light source passes through the opening of the calibration element and the transmissive original, and then enters the scanning module.

U.S. Pat. No. 7,411,704 discloses a multiple-background device for a scanner and a calibration device utilizing the same principle. The multiple-background device includes a shaft, a low-reflectance portion and a high-reflectance portion are formed along the length of the shaft. Thereby the shaft can provide various background colors, and the optical module can acquire a plurality of scan lines by means of rotating the shaft for image calibration.

U.S. Pat. No. 7,391,540 discloses a sheet-fed scanner capable of switching backgrounds. In the sheet-fed scanner, a scanning module scans a document, which is transported by a sheet-feeding mechanism across a scan region, and a stationary background component, which has a plurality of sections having different reflectivities and is disposed in the scan region. The scanning module includes an image sensor, a lens and at least one reflecting mirror. An actuator actuates the at least one reflecting mirror to enable the image sensor to selectively sense one of the sections of the background component as a scan background for the document through the lens and the at least one reflecting mirror.

However, the above calibration mechanism has a complex structure and a large volume. Since, a space in the scanner must be reserved for the above calibration mechanism to increase the volume of the scanner. It is difficult to achieve a compact size of the scanner.

### SUMMARY OF THE INVENTION

An object of the present invention is to provide a calibration mechanism capable of alternating the background color.

According to the invention, the calibration mechanism is positioned in a scanning device. The scanning device includes a scanning module having a transparent plate for being passed through a scanned light beam and creating a scanned color. The calibration mechanism includes a processor means and a display means. The display means is positioned to face the transparent plate of the scanning module and controlled by the processor means to alter the scanned color to a display color.

An object of the present invention is to provide a scanning device capable of alternating the background color.

According to the invention, the scanning mechanism includes an auto document feeder, the scanning module, the processor means and the display means. The auto document feeder conveys a document along a document conveying path. The scanning module senses a scanning light beam passing through a transparent plate positioned beside the document conveying path and creating a scanned color. The display means is positioned to face the transparent plate of the scanning module and beside the document conveying path. The display means is controlled by the processor means to alter the scanned color to a display color.

Since, the calibration mechanism positioned in the scanning device is capable altering the background color. Furthermore, the calibration mechanism has a simple structure and a compact size for conveniently positioned in a compact scanning device.

### BRIEF DESCRIPTION OF THE DRAWINGS

The present invention will be apparent to those skilled in the art by reading the following description of preferred embodiments thereof, with reference to the attached drawings, in which:

FIG. 1 shows a calibration mechanism positioned in a scanning device with an auto document feeder according to the present invention;

FIG. 2 is a block diagram showing a first preferred embodiment of the calibration mechanism according to the present invention;

FIG. 3 shows a first preferred embodiment of a display means of the calibration mechanism according to the present invention;

FIG. 4 shows the display means of the calibration mechanism positioned to face a scanning module of the scanning device according to the present invention;

FIG. 5 shows a second preferred embodiment of the display means of the calibration mechanism according to the present invention; and

FIG. 6 is a block diagram showing a second preferred embodiment of the calibration mechanism according to the present invention.

### DETAILED DESCRIPTION OF THE PREFERRED EMBODIMENT

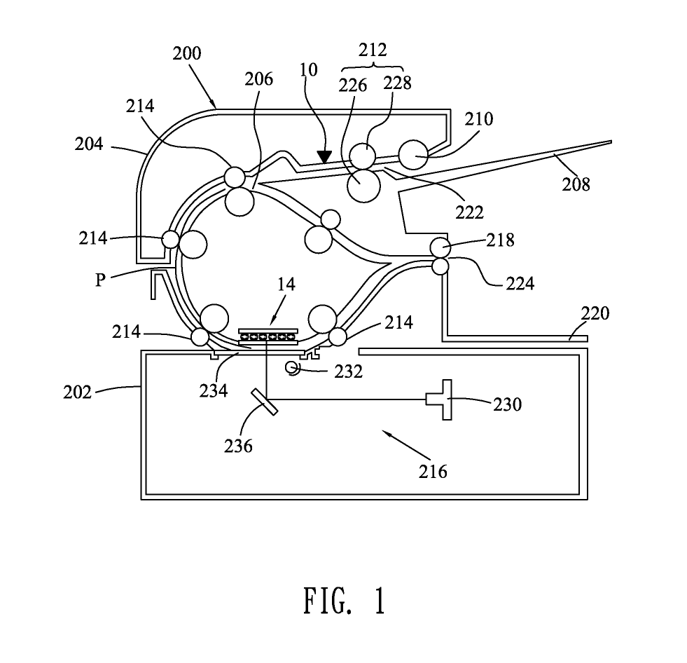

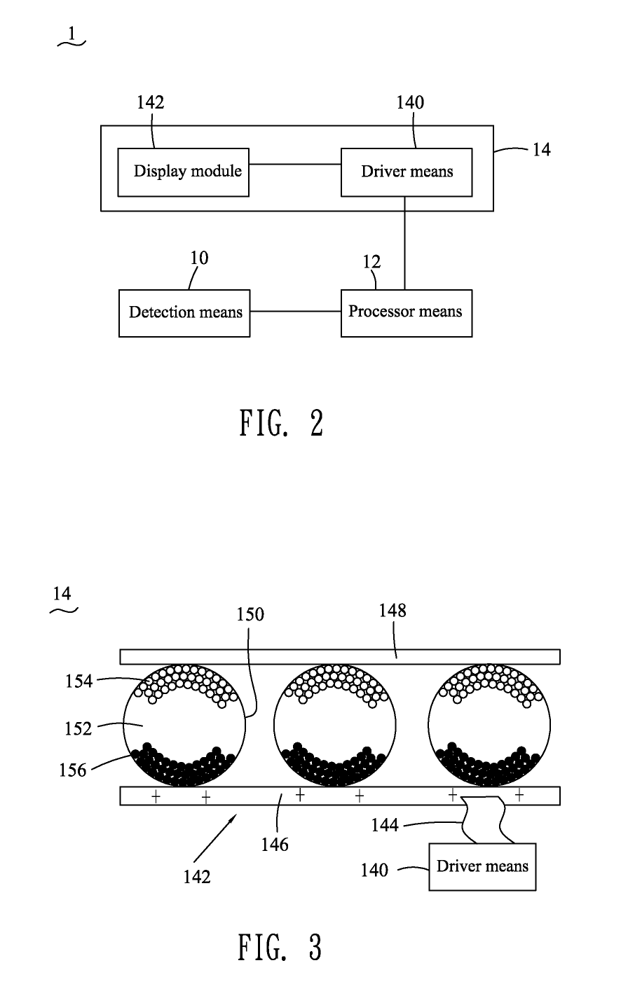

Please refer to FIG. 1 and FIG. 2. A calibration mechanism 1 is positioned in a scanning device 200 and includes a detection means 10, a processor means 12 and a display means 14. The scanning device 200 includes a base 202 and an auto document feeder 204 positioned on the base 202.

The auto document feeder 204 includes a document conveying path 206, an input tray 208, a picking up module 210, a separating module 212, a plurality of conveying rollers 214, a scanning module 216, a discharging module 218 and an output tray 220. The document conveying path 206 defines an upstream section 222 and a downstream section 224 respectively connected to the outside of the auto document feeder 204.

The input tray 208 is connected to the auto document feeder 203 and positioned to adjacent to the upstream section 222 for being put a bundle of documents. The picking up module 210 is positioned at the upstream section 222 for picking up a document from the input tray 208 and conveying the document into the document conveying path 206.

The separating means 212 includes a driving roller 226 and a driven roller 228, which is positioned at the upstream section 222 and at a downstream position relative to the picking up means 210. The separating means 212 separates overlapping documents into a single document P and conveying the single document P to the downstream section 224. Especially, the driven roller can be replaced by a separating pad.

The conveying rollers 214 are dispersed along the document conveying path 206 for conveying the document P from the upstream section 222 to the downstream section 224. The discharging means 218 is positioned at the downstream section 224 for discharging the document P from the document conveying path 206. Since, the document P is put on the output tray 220.

The scanning module 216 includes an optical sensor 230, a light source 232, a transparent plate 234 and a reflective plate 236, which is positioned beside the document path 2206 and in the base 204. The light source 232 radiates a light beam to the document conveyed by the conveying rollers 214. The light beam is reflected by the document, and then passing the transparent plate 234, and then reflected by the reflective plate 236, and then received by the optical sensor 230. The optical sensor 230 transforms the light beam into an image. The transparent plate 234 is positioned beside the document conveying path 206 for protecting the scanning module 216 and preventing the scanning module 216 from dust.

The detection means 10 of the calibration mechanism 1 is positioned beside the document conveying path 206 and at a downstream position relative to the separating means 212 and at an upstream position relative to the scanning module 216. The display means 14 of the mechanism 1 is positioned beside the conveying path 206 and to face the transparent plate 234 of the scanning module 216. Especially, the detection means 10 is positioned to close to the separating means 212. The processor means 12 interconnects the detection means 10 and the display means 14.

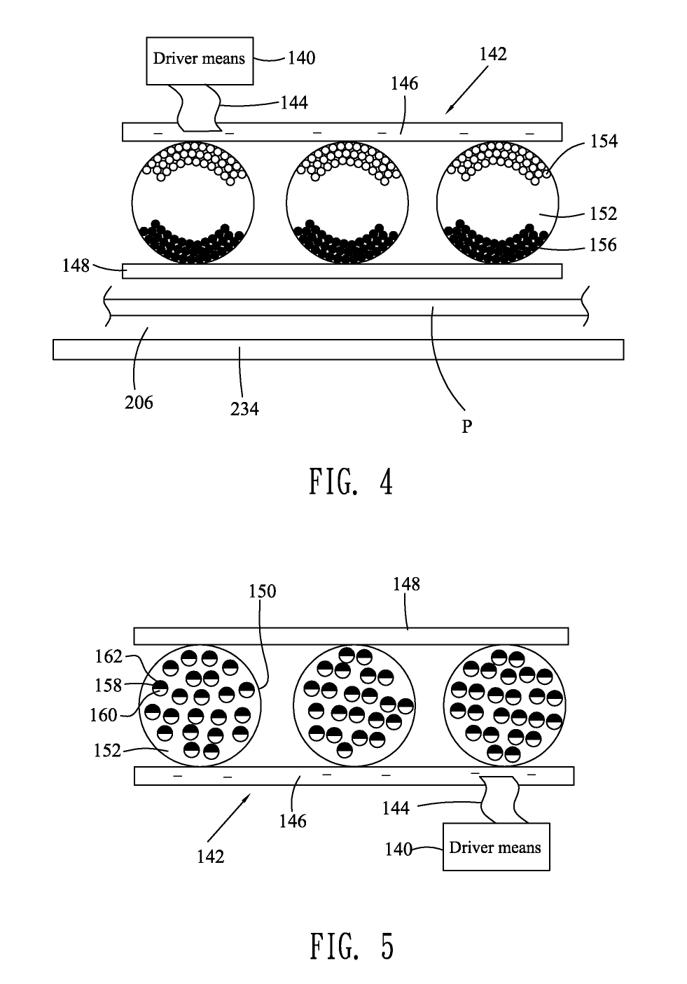

Please refer to FIG. 3 and FIG. 4. A first preferred embodiment of the display means 14 includes a driver means 140 and a display module 142. The driver means 140 interconnects the processor means 12 and the display module 142. Especially, the driver means 140 connects to the display module 142 through a signal bus 144. Especially, the signal bus can be replaced by a plurality of signal wire.

The display module 142 includes an electrode plate 146, a transparent electrode plate 148 and a plurality of microcapsules 150 positioned between the electrode plate 146 and the transparent electrode panel 148. The driver means 142 connects to the electrode plate 146 and the transparent electrode panel 148 through the signal bus 144.

Each microcapsules includes a transparent fluid 152, a plurality of positively charged white particle 154 and a plurality of negatively charged black particle 156 respectively positioned inside thereof. The transparent electrode panel 148 of the display module 142 is positioned to face to the transparent plate 234 of the scanning module 214.

If the scanning device 200 is operating, the document P is conveyed to pass to the detection means, 10 and then the detection means 10 will detect the color of the document P to send a detection signal to the processor means 12. The processor means 12 receives and judges the detection signal and then send an indication signal related to the detection signal to the driver means 140. The driver means is controlled to drive the electrode plate 146 and the transparent electrode plate 148 by the indication signal from the processor. Especially, the driver means 140 sends a driver signal to the electrode plate 146 and the transparent electrode plate 148 through the signal bus 144 for driving the electrode plate 146 and the transparent electrode plate 148.

If the color of the document P detected by the detection means 10 is black, the processor means 12 will control the driver means 140 to drive the electrode plate 146 and the transparent electrode plate 148. Then, the electrode plate 146 will be driven to become positive potential and the transparent electrode plate 148 will be driven to become negative potential. Since, the negatively charged black particles 156 are moved to close to the electrode plate 146 with positive potential, and the positively charged white particle 154 are moved to close to the transparent electrode panel 148 with negative potential. Therefore, the display module 142 of the calibration mechanism 1 will show the document as white color.

If the color of the document P detected by the detection means 10 is white, the processor means 12 will control the driver means 140 to drive the electrode plate 146 and the transparent electrode plate 148. Then, the electrode plate 146 is driven to become negative potential and the transparent electrode plate 148 is driven to become positive potential. Since, the positively charged white particles 154 are moved to close to the electrode plate 146 with negative potential, and the negatively charged black particle 156 are moved to close to the transparent electrode panel 148 with positive potential. Therefore, the display module 142 of the calibration mechanism 1 will show the document as the black color.

Since, the contrast is great enough between the color of the document and the color of the display module 142 of the calibration mechanism 1 for improving de-skew function and edge detection function of the scanning device 200, and for adjusting shade of the scanning module 214 of the scanning device 200. Especially, the transparent electrode plate 148 can be replaced by a transparent panel.

Please refer to FIG. 5. A second preferred embodiment of the display means 14 is that the positively charged white particle 154 and the negatively charged black particle 156 are replaced by a Gyricon bead 158. The Gyricon bead 158 includes a positively charged white hemisphere 160 and a negatively charged black hemisphere 162.

If the color of the document P detected by the detection means 10 is black, the processor means 12 will control the driver means 140 to drive the electrode plate 146 and the transparent electrode plate 148. Then, the electrode plate 146 is driven to become positive potential and the transparent electrode plate 148 is driven to become negative potential. Since, the Gyricon bead 158 is driven to rotate, and then the positively charged white hemisphere 160 is rotated to face the transparent electrode plate 148 with negative potential and the negatively charged black hemisphere 162 is rotated to face the electrode plate 146 with positive potential.

If the color of the document P detected by the detection means 10 is white, the processor means 12 will control the driver means 140 to drive the electrode plate 146 and the transparent electrode plate 148. Then, the electrode plate 146 is driven to become negative potential and the transparent electrode plate 148 is driven to become positive potential.

Since, the Gyricon bead 158 is driven to rotate, and then the positively charged white hemisphere 160 is rotated to face the electrode plate 146 with negative potential and the negatively charged black hemisphere 162 is rotated to face the transparent electrode plate 148 with positive potential. Especially, the microcapsule 150 can be replaced by a accommodating means, the positively charged white particle 154 can be replaced by a positively charged light particle, and the negatively charged black particle 156 can be replaced by a negatively charged dark particle.

Since, if the document is white, the display module 142 will show it as black. If the document is black, the display module 142 will show it as white. The contrast is great enough between the color of the document and the color of the display module 142 of the calibration mechanism 1 for improving de-skew function and edge detection function of the scanning device 200, and for adjusting shade of the scanning module 214 of the scanning device 200.

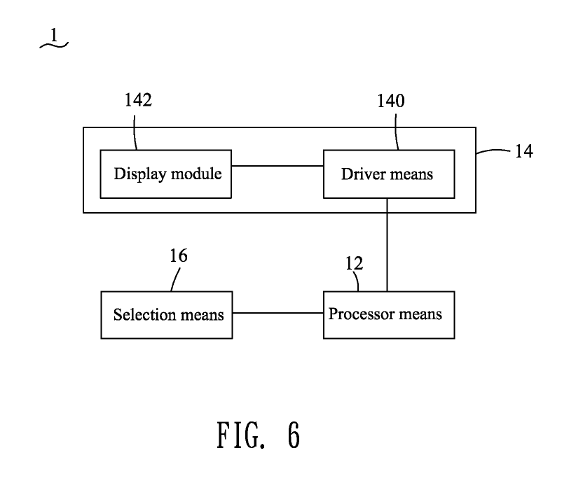

Please refer to FIG. 6. A second preferred embodiment of the calibration mechanism 1 is that the detection means 10 is replaced by a selection means 16. The color sensed by the display module 142 of the calibration mechanism 1 will be altered by manually controlling the selection means 16. Since, the selection means 16 provides a selection to the processor means 14. The processor means 16 judges the selection signal to control the driver means 142. Especially, the selection means 16 includes a button, a joystick, a switch, etc, which is positioned on the base 202 or the auto document feeder 204 of the scanning device 200.

As described above, the calibration mechanism 1 has simple structure and compact size for conveniently positioned in the scanning device 200. Furthermore, the calibration mechanism 1 is adapted to a compact scanning device.

Furthermore, the present invention is not limited to the embodiments described above; diverse additions, alterations and the like may be made within the scope of the present invention by a person skilled in the art. For example, respective embodiments may be appropriately combined.

What is claimed is:

1. A calibration mechanism positioned in a scanning device, the scanning device comprising a scanning module having a transparent plate for being passed through a scanned light beam and creating a scanned color, the calibration mechanism comprising:
a processor means; and
a display means positioned to face the transparent plate of the scanning module and controlled by the processor means to alter the scanned color to a display color.

2. The calibration mechanism as claimed in claim 1, wherein the scanning device includes an auto document feeder and a document conveying path for conveying a document, the scanning module is fixed in the scanning, the transparent plate of the scanning module is positioned beside the document conveying path, the display module means is positioned beside the document conveying path.

3. The calibration mechanism as claimed in claim 2, wherein the display means comprises
a display module; and
a driver means controlled by the processor means to drive the display module to alter the scanned color to the display color.

4. The calibration mechanism as claimed in claim 3, wherein the display module comprises
a transparent panel positioned beside the document conveying path and to face the transparent plate of the scanning module;
an electrode plate driven by the driver means for altering the pole thereof;
a plurality of accommodating means positioned between the transparent panel and the electrode plate;
a positively charged material with a first color positioned in each accommodating; and
a negatively charged material with a second color positioned in each accommodating means, one of the first color and the second color is dark and the other one is light.

5. The calibration mechanism as claimed in claim 4, wherein the accommodating means is a microcapsule, the positively charged material is a positively charged white particle, and the negatively charged material is a negatively charged black particle.

6. The calibration mechanism as claimed in claim 5, wherein the microcapsule is filled a transparent fluid.

7. The calibration mechanism as claimed in claim 6, wherein the transparent panel is a transparent electrode plate driven by the driver means to alter the pole thereof.

8. The calibration mechanism as claimed in claim 7, further comprising a detection means for detecting a color of the document and providing a detection signal, the processor means judging the detection signal for controlling the driver means.

9. The calibration mechanism as claimed in claim 8, wherein the detection means is positioned at an upstream section of the conveying path.

10. The calibration mechanism as claimed in claim 7, further comprising a selection means for being operated to providing a selection signal, the processor means judging the selection signal for controlling the driver means.

11. The calibration mechanism as claimed in claim 4, wherein the accommodating means is a Gyricon bead, the positively charged material is a positively charged white hemisphere, the negatively charged material is a negatively charged black hemisphere.

12. The calibration mechanism as claimed in claim 11, wherein the transparent panel is a transparent electrode plate driven by the driver means to alter the pole thereof.

13. The calibration mechanism as claimed in claim 12, further comprising a detection means for detecting a color of the document and providing a detection signal, the processor means judging the detection signal for controlling the driver means.

14. The calibration mechanism as claimed in claim 13, wherein the detection means is positioned at an upstream section of the conveying path.

15. The calibration mechanism as claimed in claim 12, further comprising a selection means for being operated to providing a selection signal, the processor means judging the selection signal for controlling the driver means.

16. A scanning device comprising:
an auto document feeder for conveying a document along a document conveying path;
a scanning module sensing a scanning light beam passing through a transparent plate positioned beside the document conveying path and creating a scanned color;
a processor means;
a display means positioned to face the transparent plate of the scanning module and beside the document conveying path, the display means controlled by the processor means to alter the scanned color to a display color.

17. The scanning device as claimed in claim 16, wherein the display means comprises
a display module; and
a driver means controlled by the processor means to drive the display module to alter the scanned color to the display color.

18. The scanning device as claimed in claim 17, wherein the display module comprises
a transparent panel positioned beside the document conveying path and to face the transparent plate of the scanning module;
an electrode plate driven by the driver means for altering the pole thereof;
a plurality of accommodating means positioned between the transparent panel and the electrode plate;
a positively charged material with a first color positioned in each accommodating; and
a negatively charged material with a second color positioned in each accommodating means, one of the first color and the second color is dark and the other one is light.

19. The scanning device as claimed in claim 18, wherein the accommodating means is a microcapsule, the positively charged material is a positively charged white particle, and the negatively charged material is a negatively charged black particle.

20. The scanning device as claimed in claim 19, wherein the transparent panel is a transparent electrode plate driven by the driver means to alter the pole thereof.
